(19) United States
(12) Patent Application Publication
(10) Pub. No.: US 2026/0164185 A1
(43) Pub. Date: Jun. 11, 2026

(54) SOUND GENERATION APPARATUS AND ELECTRONIC DEVICE

(71) Applicant: HUAWEI TECHNOLOGIES CO., LTD., Shenzhen (CN)

(72) Inventors: Jiayi Chen, Beijing (CN); Yujiang Ding, Shanghai (CN); CHUNJIAN LI, Shanghai (CN); Zhenxing Xu, Dongguan (CN)

(73) Assignee: HUAWEI TECHNOLOGIES CO., LTD., Shenzhen (CN)

(21) Appl. No.: 19/465,611

(22) Filed: Jan. 30, 2026

Related U.S. Application Data
(63) Continuation of application No. PCT/CN2024/142938, filed on Dec. 26, 2024.

(30) Foreign Application Priority Data
Dec. 28, 2023 (CN) 202311850218.1

(51) Int. Cl. H04R 17/10; H04R 1/24; H04R 1/28; H04R 7/04

(52) U.S. Cl. CPC H04R 17/10; H04R 1/24; H04R 1/2811; H04R 7/04; H04R 2307/027; H04R 2499/11

(57) ABSTRACT

This application provides a sound generation apparatus and an electronic device. The sound generation apparatus includes a first transducer and a second transducer. The first transducer includes a first base and a first vibration component. A peripheral edge of the first vibration component is fastened to the first base. The second transducer includes a second base and a second vibration component. The second vibration component is fastened to the second base. The second vibration component and the first vibration component are disposed opposite to and spaced apart from each other. A middle part of the first vibration component and the second transducer enclose a vibration space. The second vibration component and the peripheral edge of the first vibration component enclose an acoustic channel. The vibration space communicates with an external space through the acoustic channel.

### CROSS-REFERENCE TO RELATED APPLICATIONS

This application is a continuation of International Application No. PCT/CN 2024/142938, filed on Dec. 26, 2024, which claims priority to Chinese Patent Application No. 202311850218.1, filed on Dec. 28, 2023. The disclosures of the aforementioned applications are hereby incorporated by reference in their entireties.

### TECHNICAL FIELD

This application relates to the field of audio technologies, and in particular, to a sound generation apparatus and an electronic device.

### BACKGROUND

Speakers are widely used in numerous current consumer electronic products, providing audio entertainment and enhancing audio experience for consumers. When the speaker works at a low frequency, displacement of a diaphragm needs to be increased, so that sound pressure of the speaker at the low frequency meets a requirement. The diaphragm of the speaker needs large vibration space, resulting in a large size of the speaker.

### SUMMARY

This application provides a sound generation apparatus and an electronic device.

According to a first aspect, an embodiment of this application provides a sound generation apparatus. The sound generation apparatus includes a first transducer and a second transducer. The first transducer includes a first base and a first vibration component. A peripheral edge of the first vibration component is fastened to the first base. The second transducer includes a second base and a second vibration component. The second vibration component is fastened to the second base. The second vibration component and the first vibration component are disposed opposite to and spaced apart from each other. A middle part of the first vibration component and the second transducer enclose vibration space. The second vibration component and the peripheral edge of the first vibration component enclose an acoustic channel. The vibration space communicates with external space through the acoustic channel.

It may be understood that the middle part of the first vibration component may vibrate at a first frequency to form a first acoustic wave, and a peripheral edge of the second vibration component may undergo reciprocating motion to allow the acoustic channel to open and close at a second frequency. The first frequency is different from the second frequency, and the first acoustic wave is modulated by the acoustic channel to form a second acoustic wave. The sound generation apparatus in this application uses a sound generation method different from that of a conventional speaker. A first vibration structure also contributes to formation of the acoustic channel while forming the first acoustic wave, thereby serving a dual-purpose role with a single structure. The sound generation apparatus does not need an additional structure to form the acoustic channel, so that a size of the sound generation apparatus is small.

In some embodiments, a middle part of the second vibration component is disposed opposite to the middle part of the first vibration component. The middle part of the second vibration component is fastened to the second base. The peripheral edge of the second vibration component is disposed opposite to the peripheral edge of the first vibration component, and the peripheral edge of the second vibration component and the peripheral edge of the first vibration component enclose the acoustic channel.

It may be understood that the acoustic channel enclosed by the peripheral edge of the second vibration component and the peripheral edge of the first vibration component may be annular. The acoustic channel may be disposed around the vibration space. In this way, a length of the acoustic channel may be longer. In a process of controlling the acoustic channel to open and close at the second frequency, an adjustable range of the acoustic channel is larger.

In some embodiments, a first through hole is provided in the middle part of the second vibration component, and the middle part of the first vibration component is disposed opposite to the second base.

It may be understood that the first through hole is provided in the middle part of the second vibration component, so that a height of vibration space may be increased without increasing a height of the sound generation apparatus in a first direction, thereby reducing a risk of interference between the middle part of the first vibration component and the second vibration component or the second base during vibration, and reducing a risk of failure of the sound generation apparatus. In addition, a size of the second vibration component can be reduced, thereby saving a material, and reducing costs of the sound generation apparatus.

In some embodiments, the acoustic channel is annular.

It may be understood that, compared with a solution in which the acoustic channel is located on one side of the vibration space, this solution in which the acoustic channel is set to be annular and disposed around the vibration space may allow the length of the acoustic channel to be longer. In the process of controlling the acoustic channel to open and close at the second frequency, the adjustable range of the acoustic channel is larger.

In some embodiments, the first base is fastened to the second base, the second vibration component is fastened to one side of the second base and is spaced apart from the first base, the middle part of the first vibration component is disposed opposite to the second base, and the acoustic channel is located on one side of the vibration space.

It may be understood that, when the acoustic channel may be located on one side of the vibration space, the second acoustic wave may be transmitted from the side on which the acoustic channel is located to the external space. A sound emission direction of the sound generation apparatus may be controlled. In addition, when the sound generation apparatus is fastened to an electronic device, either the first base or the second base may be fastened to the electronic device, to fasten the sound generation apparatus. This configuration, compared with a solution in which the first base and the second base are separately mounted on the electronic device, can reduce a risk of misalignment between the first vibration component and the second vibration component. This results in high component precision of the sound generation apparatus and low mounting difficulty of the sound generation apparatus.

In some embodiments, the acoustic channel is linear or arc-shaped.

It may be understood that the acoustic channel may have a plurality of shapes, so that a direction in which a sound is emitted is adjusted. For example, when the acoustic channel is arc-shaped, a central angle corresponding to the arc may be adjusted, so that coverage of a sound emitted by the sound generation apparatus may be adjusted.

In some embodiments, there are a plurality of second vibration components, and the plurality of second vibration components are spaced apart from each other.

It may be understood that when there are a plurality of second vibration components, the plurality of second vibration components may enclose a plurality of acoustic channels together with the peripheral edge of the first vibration component. A sound emission orientation of the sound generation apparatus may be adjusted through adjustment of a position of the second vibration component.

In some embodiments, the second vibration component is circular, annular, rectangular, or arc-shaped.

It may be understood that a shape of the acoustic channel may be adjusted through adjustment of the shape of the second vibration component. There may be a plurality of choices for the shape of the second vibration component, and the sound generation apparatus may be applicable to a plurality of usage scenarios.

In some embodiments, the second vibration component is a piezoelectric sheet, the sound generation apparatus further includes a second feed circuit, and the second feed circuit is electrically connected to the second vibration component and is configured to transmit an electrical signal to the second vibration component.

It may be understood that, compared with a solution in which a conventional mechanical motion structure is used to implement the reciprocating motion of the peripheral edge of the second vibration component, the piezoelectric sheet has a smaller size. This helps reduce a size of the sound generation apparatus.

In some embodiments, the reciprocating motion is reciprocating rotation or reciprocating movement.

In some embodiments, a distance between the first vibration component and the second vibration component is less than 1 mm in a first direction, and the first direction is a direction in which the first vibration component faces the second vibration component.

It may be understood that the distance between the first vibration component and the second vibration component is small, so that a thickness of the sound generation apparatus in the first direction is small, thereby facilitating miniaturization of the sound generation apparatus. In addition, a vibration distance of the first vibration component is small, and a vibration amplitude of the middle part of the first vibration component during vibration is also small. When the sound generation apparatus is mounted in internal space of the electronic device, in a sound generation process of the sound generation apparatus, a risk that the first vibration component drives a housing and/or a keyboard of the electronic device to vibrate can be reduced, and a problem of airflow noise caused by large-amplitude vibration can be further resolved.

In some embodiments, the middle part of the first vibration component vibrates at the first frequency to form the first acoustic wave, and the peripheral edge of the second vibration component undergoes the reciprocating motion to allow the acoustic channel to open and close at the second frequency. The first frequency is different from the second frequency, and the first acoustic wave is modulated by the acoustic channel to form the second acoustic wave. The second acoustic wave includes an audible sound, and the first frequency is greater than a frequency of the audible sound in the second acoustic wave.

It may be understood that the high-frequency first acoustic wave may be modulated by the acoustic channel to form the audible sound with a low frequency, and a sound pressure value of the audible sound may be equal or close to a sound pressure value of the first acoustic wave. Compared with a sound pressure value of a sound that is emitted by the conventional speaker and that has a same frequency as the audible sound, a sound pressure value of the sound generation apparatus in this application is higher at the same frequency of the audible sound. That is, low-frequency acoustic performance of the sound generation apparatus in this application is better. In addition, compared with the conventional speaker generating a sound of a same sound pressure level, a vibration displacement of the first vibration structure of the sound generation apparatus in this application may be less than a vibration displacement of a diaphragm of the conventional speaker. This helps reduce the size of the sound generation apparatus. The sound generation apparatus can have a high low-frequency sound pressure level while maintaining a small size.

In some embodiments, a difference between the first frequency and a resonant frequency of the first vibration component is less than or equal to a threshold; and/or a difference between the second frequency and a resonant frequency of the second vibration component is less than or equal to the threshold. The threshold is less than or equal to 500 Hz.

It may be understood that the first frequency is set to be close or equal to the resonant frequency of the first vibration component, so that vibration efficiency of the sound generation apparatus can be improved. The second frequency is set to be close or equal to the resonant frequency of the second vibration component, so that the vibration efficiency of the sound generation apparatus can be improved. A person skilled in the art may design the first vibration component and the second vibration component by using a simulation tool, to allow the resonant frequency of the first vibration component and the resonant frequency of the second vibration component to conform to preset values.

In some embodiments, the first frequency f₁ is a single frequency or a frequency band range. The second frequency f₂ is a single frequency or a frequency band range.

It may be understood that the first frequency f₁ and the second frequency f₂ may be set to be a single frequency or a frequency band range to adjust a frequency band of the second acoustic wave to be a single frequency or a frequency band range.

In some embodiments, a frequency of the second acoustic wave includes ¿f₁−f₂∨¿ and ¿f₁−f₂∨¿, and the first frequency f₁ and the second frequency f₂ satisfy the following conditions: |f₁−f₂|at least partially falls within a range that is less than or equal to 20 kHz, and 20 kHz≤∨f₁+f₂∨¿.

It may be understood that, values of the first frequency f₁ and the second frequency f₂ are set, so that the second acoustic wave includes sounds of two frequencies, one of the sounds is an audible sound, and the other may fall within a frequency range of an ultrasonic wave. When the sound generation apparatus generates a sound, the frequency that is of the second acoustic wave and that is within the ultrasonic range is not received by a user, and the user hears only one audible sound, so that noise of the sound generation apparatus is low.

In some embodiments, the first frequency f₁ and the second frequency, and f₂≥20 kHz.

It may be understood that, both the first frequency f₁ and the second frequency f₂ are set to ultrasonic frequencies, and when the sound generation apparatus generates a sound, the first frequency f₁ and the second frequency f₂ are not heard by the user, so that noise of the sound generation apparatus is low. In addition, both the first frequency f₁ and the second frequency f₂ are set to be ultrasonic, which may further ensure that an acoustic wave of the frequency |f₁+f₂| in the second acoustic wave may fall within the frequency range of the ultrasonic wave, so that the acoustic wave of the frequency |f₁+f₂| in space can be inaudible to a human ear. In addition, both the first frequency f₁ and the second frequency f₂ are set to be ultrasonic, so that the sound generation apparatus can obtain a large sound pressure value under a small vibration displacement. When the frequency ¿f₁−f₂∨¿ is the audible sound, the sound pressure value of the second acoustic wave is large, and low-frequency performance of the sound generation apparatus is good.

According to a second aspect, an embodiment of this application provides an electronic device. The electronic device includes a sound generation apparatus. In this way, a size of the sound generation apparatus is small, which facilitates miniaturization of the electronic device.

In some embodiments, the electronic device may further include a housing, and the sound generation apparatus is mounted on the housing.

### BRIEF DESCRIPTION OF DRAWINGS

To describe technical solutions in embodiments of this application, the following describes accompanying drawings used in embodiments of this application.

FIG. 1 is a diagram of a partial structure of an electronic device according to an embodiment of this application;

FIG. 2 is an exploded diagram of an example of the electronic device shown in FIG. 1;

FIG. 3 is a partial sectional view of an example of the electronic device shown in FIG. 1 along a section line A-A;

FIG. 4 is a diagram of a structure of an example of a sound generation apparatus shown in FIG. 2;

FIG. 5 is an exploded diagram of an example of the sound generation apparatus shown in FIG. 4;

FIG. 6 is a partial sectional view of an example of the sound generation apparatus shown in FIG. 4 along a section line B-B;

FIG. 7 is a diagram of a structure of the sound generation apparatus shown in FIG. 4 from another angle;

FIG. 8 is an exploded diagram of another example of the sound generation apparatus shown in FIG. 4;

FIG. 9 is a partial sectional view of another example of the sound generation apparatus shown in FIG. 4 along a section line B-B;

FIG. 10 is a diagram of a structure of another example of a sound generation apparatus according to an embodiment of this application from another angle;

FIG. 11 is a partial sectional view of an example of the sound generation apparatus shown in FIG. 10 along a section line C-C;

FIG. 12a is a diagram of a structure of still another example of a sound generation apparatus according to an embodiment of this application from another angle;

FIG. 12b is a diagram of a structure of still another example of a sound generation apparatus according to an embodiment of this application from another angle; and

FIG. 13 is a partial sectional view of another example of the electronic device shown in FIG. 1 along a section line A-A.

### DETAILED DESCRIPTION

The following describes technical solutions in embodiments of this application with reference to the accompanying drawings. In the descriptions of embodiments of this application, unless otherwise stated, “/” indicates “or”. For example, A/B may indicate A or B. The term “and/or” in this specification describes only an association relationship between associated objects and indicates that three relationships may exist. For example, A and/or B may indicate the following three cases: Only A exists, both A and B exist, and only B exists. In addition, in the descriptions of embodiments of this application, “a plurality of” means two or more than two.

In the following descriptions, terms such as “first” and “second” are merely intended for a purpose of description, and shall not be understood as an indication or implication of relative importance or an implicit indication of a quantity of indicated technical features. Therefore, a feature limited by “first” or “second” may explicitly or implicitly include one or more features.

Orientation terms mentioned in embodiments of this application, for example, “upper”, “lower”, “inner”, “outer”, “side”, “top”, and “bottom” are merely directions with reference to the accompanying drawings. Therefore, the orientation terms are used to better and more clearly describe and understand embodiments of this application, instead of indicating or implying that a specified apparatus or element needs to have a specific orientation, or be constructed and operated in a specific orientation. Therefore, this cannot be understood as a limitation on embodiments of this application.

In the descriptions of embodiments of this application, it should be noted that, unless otherwise specified and limited, terms such as “mount”, “connected to”, “connection”, and “disposed on” should be understood in a broad sense. For example, “connection” may be a detachable connection, a nondetachable connection, a direct connection, or an indirect connection through an intermediate medium. A “fixed connection” may mean that parts are connected to each other and a relative position relationship remains unchanged after the parts are connected. A “rotatable connection” may mean that parts are connected to each other and can rotate relative to each other after being connected. A “slidable connection” may mean that parts are connected to each other and can slide relative to each other after being connected. An “electrical connection” means that an electrical signal may be conducted between each other.

In addition, in embodiments of this application, mathematical concepts such as parallel are mentioned. These limitations are all for the current process level, but not for an absolute strict definition in the mathematical sense. A small deviation is allowed, which can be approximately parallel. For example, that A is parallel to B means that A is parallel or approximately parallel to B, and an included angle of 0 degrees to 10 degrees between A and B is allowed.

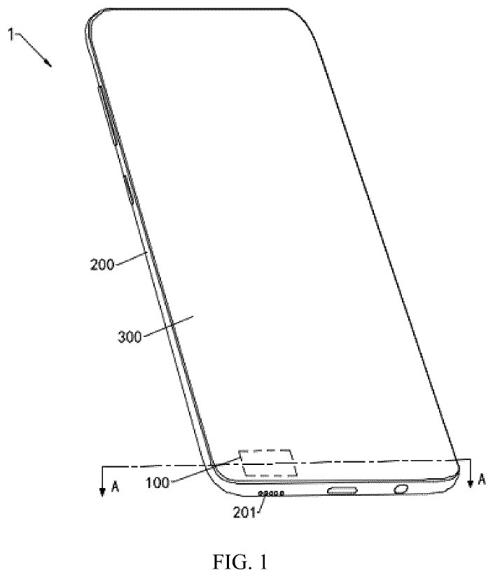

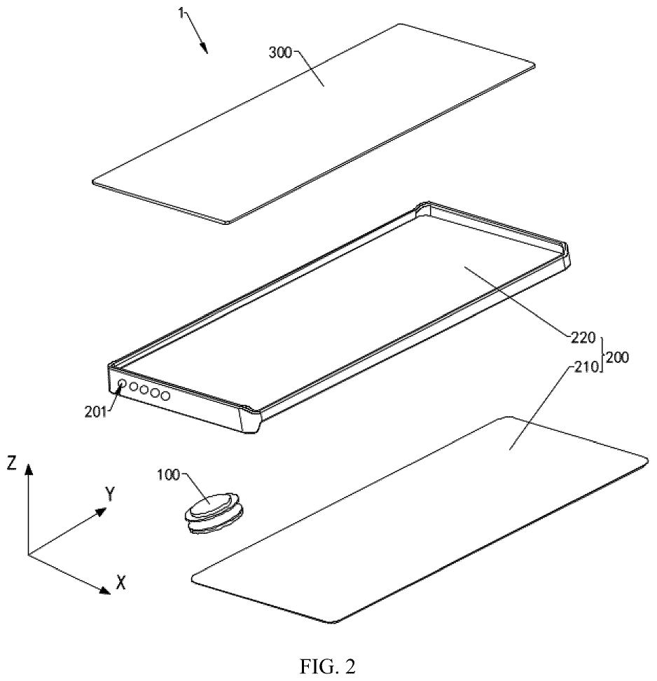

FIG. 1 is a diagram of a partial structure of an electronic device 1 according to an embodiment of this application. FIG. 2 is an exploded diagram of an example of the electronic device 1 shown in FIG. 1.

As shown in FIG. 1, the electronic device 1 includes a sound generation apparatus 100, a housing 200, and a screen 300. The electronic device 1 may be an electronic device 1 that needs to output an audio through the sound generation apparatus 100, for example, a mobile phone, a tablet, a hearing aid, or a smart wearable device. The smart wearable device may be a smartwatch, augmented reality (AR) glasses, an AR helmet, virtual reality (VR) glasses, or the like. Alternatively, the electronic device 1 may be a device that can output an audible sound, for example, a headset or a player. In addition, the sound generation apparatus 100 may be further used in fields such as a whole house, a smart home, and a vehicle as an audio device or a part of an audio device. In the embodiment shown in FIG. 1, an example in which the electronic device 1 is a mobile phone is used for description.

Because the sound generation apparatus 100 is an internal component of the electronic device 1, FIG. 1 schematically shows the sound generation apparatus 100 through a dashed line. It may be understood that FIG. 1 and the following related accompanying drawings merely schematically show some components included in the electronic device 1. Actual shapes, actual sizes, actual positions, and actual structures of these components are not limited by FIG. 1 and the following accompanying drawings. In addition, when the electronic device 1 is a device in another form, the electronic device 1 may not include the screen 300.

The screen 300 is mounted on the housing 200. The housing 200 and the screen 300 may form a casing of the electronic device 1. The screen 300 may enclose an internal cavity of the electronic device 1 together with the housing 200. The sound generation apparatus 100 may be mounted in the internal cavity of the electronic device 1. The housing 200 has a sound outlet 201. The internal cavity of the electronic device 1 communicates with external space of the electronic device 1 through the sound outlet 201. In this case, a sound emitted by the sound generation apparatus 100 may be transmitted out of the electronic device 1 through the sound outlet 201. It may be understood that a shape of the sound outlet 201 is not limited to a cylindrical hole shown in FIG. 1. The shape of the sound outlet 201 may alternatively be a special-shaped hole. A quantity of sound outlets 201 is not limited to five shown in FIG. 1.

For example, the housing 200 may include a rear cover 210 and a middle frame 220. The screen 300 and the rear cover 210 are respectively connected to two sides of the middle frame 220. The screen 300 and the middle frame 220 may enclose a first internal cavity 2 of the electronic device 1, and the rear cover 210 and the middle frame 220 may enclose a second internal cavity 3 of the electronic device 1. An internal component of the electronic device 1 may be disposed in the first internal cavity 2 or the second internal cavity 3 based on a requirement. For example, the sound generation apparatus 100 may be disposed in the second internal cavity 3.

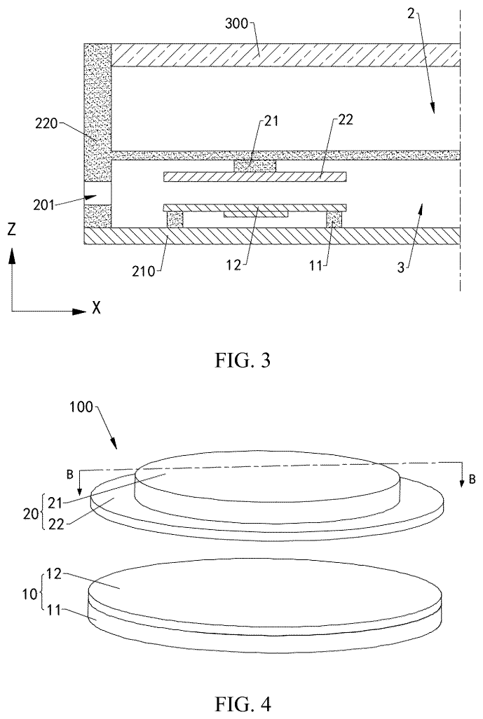

FIG. 3 is a partial sectional view of an example of the electronic device 1 shown in FIG. 1 along a section line A-A. FIG. 4 is a diagram of a structure of an example of the sound generation apparatus 100 shown in FIG. 2.

As shown in FIG. 3 and FIG. 4, the sound generation apparatus 100 may include a first transducer 10 and a second transducer 20. The first transducer 10 includes a first base 11 and a first vibration component 12. A peripheral edge 124 of the first vibration component 12 is fastened to the first base 11. The second transducer 20 includes a second base 21 and a second vibration component 22. The second vibration component 22 is fastened to the second base 21. The second vibration component 22 and the first vibration component 12 are disposed opposite to and spaced apart from each other. It should be noted that, that the first vibration component 12 and the second vibration component 22 are disposed opposite to each other means that projections of the first vibration component 12 and the second vibration component 22 on a reference plane in a first direction at least partially overlap, the first direction is a direction in which the first vibration component 12 faces the second vibration component 22, and the reference plane is perpendicular to the first direction.

The first base 11 may be configured to fasten the first vibration component 12. The second base 21 may be configured to fasten the second vibration component 22. For example, when the first sound generation apparatus 100 is mounted in the second internal cavity 3 of the electronic device 1, the first base 11 of the first transducer 10 may be fastened to the rear cover 210, and the first vibration component 12 may be fastened to the rear cover 210 via the first base 11. The second base 21 of the second transducer 20 may be fastened to the middle frame 220, and the second vibration component 22 may be fastened to the middle frame 220 via the second base 21. In another example, the first base 11 of the first transducer 10 may alternatively be fastened to the middle frame 220, and the second base 21 of the second transducer 20 may be fastened to the rear cover 210.

In another example, the sound generation apparatus 100 may alternatively be disposed in the first internal cavity 2. For example, the first base 11 of the first transducer 10 may be fastened to the screen 300, and the second base 21 of the second transducer 20 may be fastened to the middle frame 220. In another example, the first base 11 of the first transducer 10 may alternatively be fastened to the middle frame 220, and the second base 21 of the second transducer 20 may be fastened to the screen 300.

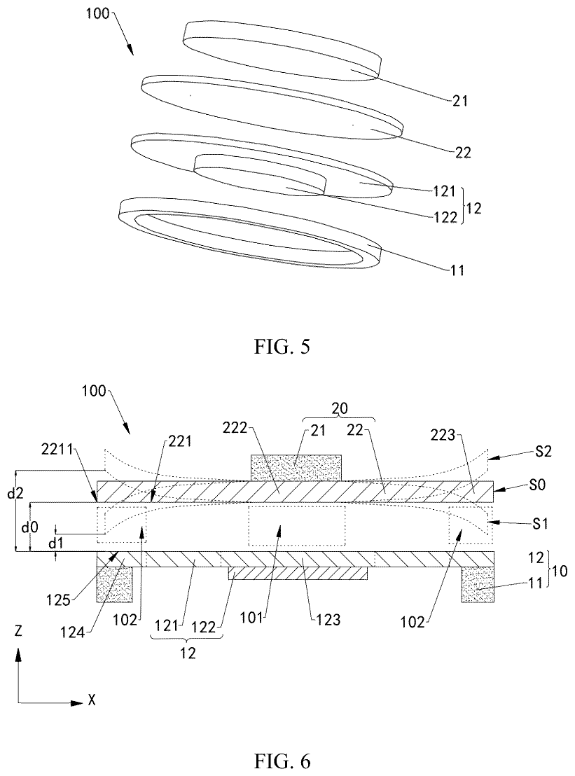

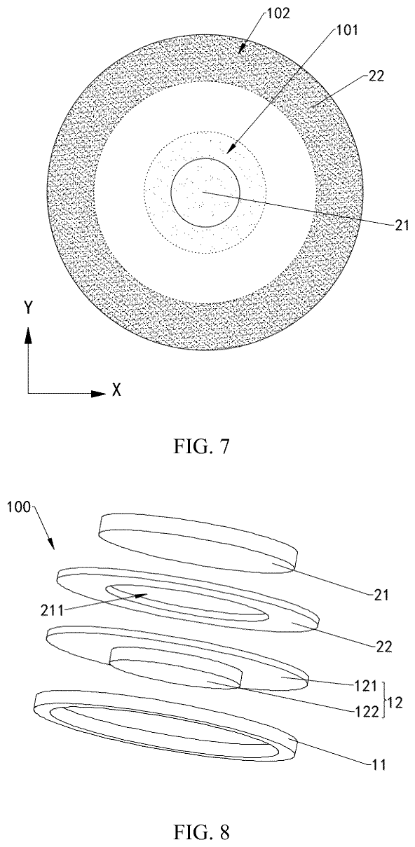

FIG. 5 is an exploded diagram of an example of the sound generation apparatus 100 shown in FIG. 4. FIG. 6 is a partial sectional view of an example of the sound generation apparatus 100 shown in FIG. 4 along a section line B-B. FIG. 7 is a diagram of a structure of the sound generation apparatus 100 shown in FIG. 4 from another angle. For ease of understanding, in FIG. 6, vibration space 101 and an acoustic channel 102 are schematically shown by using dashed-line boxes. In FIG. 7, the vibration space 101 and the acoustic channel 102 are schematically shown by using a filling pattern.

As shown in FIG. 5, FIG. 6, and FIG. 7, a middle part 123 of the first vibration component 12 and the second transducer 20 may enclose the vibration space 101 (the vibration space 101 is schematically shown by using a dashed-line box in FIG. 6). The middle part 123 of the first vibration component 12 may vibrate at a first frequency, to form a first acoustic wave. A frequency of the first acoustic wave may be equal to the first frequency.

For example, the first vibration component 12 may include a diaphragm 121 and a first vibration structure 122. The first vibration structure 122 may be fastened to a middle part of the diaphragm 121 (the middle part of the diaphragm 121 is schematically shown by using a dashed line in FIG. 6). The middle part of the diaphragm 121 and the first vibration structure 122 may form the middle part 123 of the first vibration component 12. The first vibration structure 122 may be configured to drive the middle part of the diaphragm 121 to vibrate at the first frequency, to push air in the vibration space 101 to vibrate and form the first acoustic wave. A peripheral edge of the diaphragm 121 may be fastened to the first base 11. The peripheral edge of the diaphragm 121 may form the peripheral edge 124 of the first vibration component 12. It should be noted that the middle part is a part between two points. In FIG. 6, the middle part 123 of the first vibration component 12 is located between the peripheral edges 124 on two sides.

In some embodiments, the middle part 123 of the first vibration component 12 may vibrate in the first direction. The first direction is the direction in which the first vibration component 12 faces the second vibration component 22. In another example, a vibration direction of the middle part 123 of the first vibration component 12 may alternatively be set at an angle to the first direction.

For example, the first vibration structure 122 may be fastened to a surface of the diaphragm 121 on a side away from the second vibration component 22. The first base 11 may be fastened to a surface of the diaphragm 121 on a side away from the second vibration component 22. In another example, the first vibration structure 122 may be fastened to a surface of the diaphragm 121 on a side close to the second vibration component 22.

As shown in FIG. 5, the first base 11 may be in an annular shape. The first vibration structure 122 may be located in a ring of the first base 11. In this way, a connection area between the peripheral edge of the diaphragm 121 and the first base 11 is large. In addition, the first base 11 may be in an annular shape, and the peripheral edge of the diaphragm 121 is fastened to the first base 11. The diaphragm 121 experiences a balanced force during vibration, thereby avoiding shaking of the diaphragm 121 from side to side.

In some embodiments, the first vibration structure 122 may use a structure of a piezoelectric sheet. The sound generation apparatus 100 may further include a first feed circuit (not shown in the figure). The first feed circuit is electrically connected to the first vibration structure 122, and is configured to transmit an electrical signal to the first vibration structure 122. For example, the first vibration structure 122 may include a piezoelectric material layer. For example, the piezoelectric material layer may be made of a piezoelectric material like lead zirconate titanate piezoelectric ceramics (lead zirconate titanate piezoelectric ceramics, PZT for short). The electrical signal is transmitted to the first vibration structure 122, so that the first vibration structure 122 may vibrate at the first frequency, and the middle part of the diaphragm 121 may be driven to vibrate at the first frequency. It may be understood that the electrical signal transmitted to the first vibration structure 122 is adjusted, to change a vibration frequency of the first vibration structure 122. A person skilled in the art may set a range of the first frequency based on a requirement.

It may be understood that, compared with a solution in which a magnetic circuit system is used in a conventional speaker to implement vibration of the diaphragm 121, the first vibration structure 122 uses the structure of the piezoelectric sheet, and the piezoelectric sheet has a smaller size. This helps reduce a size of the sound generation apparatus 100.

It may be understood that the piezoelectric sheet is merely an embodiment in which the first vibration component 12 implements vibration. In another embodiment, the first vibration structure 122 may alternatively use a mechanical vibration structure to implement vibration of the diaphragm 121. A manner in which the first vibration component 12 implements vibration is not limited in this application.

In some embodiments, the diaphragm 121 may be made of a metal material. In this way, strength of the diaphragm 121 is good.

In some embodiments, a difference between the first frequency and a resonant frequency of the first vibration component 12 is less than or equal to a threshold. It should be noted that the difference between the first frequency and the resonant frequency of the first vibration component 12 is an absolute value. The difference between the first frequency f₁ and the resonant frequency f₃ of the first vibration component 12 is ¿f₁−f₃∨¿. In other words, the first frequency f₁ may be greater than or equal to the resonant frequency f₃ of the first vibration component 12, or may be less than or equal to the resonant frequency f₃ of the first vibration component 12.

In some embodiments, the threshold may be less than or equal to 500 Hz. For example, the threshold may be 500 Hz, and the first frequency f₁ and the resonant frequency f₃ of the first vibration component 12 satisfy the following condition: ¿f₁−f₃∨¿≤500 Hz. In another embodiment, the threshold may alternatively be 20 Hz, 100 Hz, 200 Hz, or the like. It may be understood that the first frequency is set to be close or equal to the resonant frequency of the first vibration component 12, so that vibration efficiency of the sound generation apparatus 100 can be improved. A person skilled in the art may design the first vibration component 12 by using a simulation tool, to allow the resonant frequency of the first vibration component 12 to conform to a preset value.

As shown in FIG. 6 and FIG. 7, the second vibration component 22 may enclose the acoustic channel 102 together with the peripheral edge 124 of the first vibration component 12 (the acoustic channel 102 is schematically shown by using a dashed-line box in FIG. 6). The vibration space 101 communicates with the external space through the acoustic channel 102. In this way, the first acoustic wave may also be transmitted to the external space through the acoustic channel 102. It should be noted that the external space is external space of the sound generation apparatus 100. For example, when the sound generation apparatus 100 is disposed inside the electronic device 1, the outside may be internal space of the electronic device 1 (for example, the second internal cavity 3 shown in FIG. 3). When the sound generation apparatus 100 is exposed from the electronic device 1, the external space may be an external environment in which the sound generation apparatus 100 or the electronic device 1 is located. The communication may be direct communication or indirect communication. The peripheral edge 124 of the first vibration component 12 is a peripheral part that is of the first vibration component 12 and that is close to the external space.

A peripheral edge 223 of the second vibration component 22 undergoes reciprocating motion to allow the acoustic channel 102 to open and close at a second frequency, and the second frequency is different from the first frequency. The first acoustic wave is modulated by the acoustic channel 102 to form a second acoustic wave. The peripheral edge 223 of the second vibration component 22 is an edge of the second vibration component 22 on a side away from the vibration space 101.

It may be understood that the sound generation apparatus 100 in this application uses a sound generation method different from that of the conventional speaker. The middle part of the first vibration structure 122 is configured to vibrate at the first frequency to form the first acoustic wave. In addition, the peripheral edge 223 of the second vibration component 22 and the first vibration structure 122 enclose the acoustic channel 102, and the second vibration component 22 undergoes the reciprocating motion relative to the peripheral edge of the first vibration component 12 to allow the acoustic channel 102 to open and close at the second frequency. In this way, the first acoustic wave may be modulated by the acoustic channel 102 to form the second acoustic wave. The first vibration structure 122 also contributes to formation of the acoustic channel 102 while forming the first acoustic wave, thereby serving a dual-purpose role with a single structure. The sound generation apparatus 100 does not need an additional structure to form the acoustic channel 102, so that the size of the sound generation apparatus 100 can be reduced. Compared with the conventional speaker, the sound generation apparatus 100 in this application has a simpler structure and lower processing and assembling difficulty.

In some embodiments, the second acoustic wave may include an audible sound, and the first frequency may be greater than a frequency of the audible sound in the second acoustic wave. It may be understood that the high-frequency first acoustic wave may be modulated by the acoustic channel 102 to form the audible sound with a low frequency, and a sound pressure value of the audible sound may be equal or close to a sound pressure value of the first acoustic wave. Compared with a sound pressure value of a sound that is emitted by the conventional speaker and that has a same frequency as the audible sound, a sound pressure value of the sound generation apparatus 100 in this application is higher at the same frequency of the audible sound. That is, low-frequency acoustic performance of the sound generation apparatus 100 in this application is better.

The following describes an embodiment of opening and closing the acoustic channel 102 with reference to FIG. 6.

Refer to FIG. 6 again. Opening and closing of the acoustic channel 102 include two motions: opening the acoustic channel 102 and closing the acoustic channel 102. The two motions are both processes, but not only instantaneous states. The peripheral edge 223 of the second vibration component 22 undergoes the reciprocating motion, and the peripheral edge 223 of the second vibration component 22 is close to or away from the peripheral edge 124 of the first vibration component 12, so that the acoustic channel 102 continuously repeats an opening process and a closing process. When the sound generation apparatus 100 does not work, a distance between the peripheral edge 223 of the second vibration component 22 and the peripheral edge 124 of the first vibration component 12 is d0. During the closing process of the acoustic channel 102, the peripheral edge 223 of the second vibration component 22 is close to the peripheral edge 124 of the first vibration component 12, and the distance between the peripheral edge 223 of the second vibration component 22 and the peripheral edge 124 of the first vibration component 12 gradually decreases until the distance between the peripheral edge 223 of the second vibration component 22 and the peripheral edge 124 of the first vibration component 12 reaches a preset minimum value (for ease of description, the minimum value is represented by d1 below). The acoustic channel 102 is switched from the closing process to the opening process. During the opening process of the acoustic channel 102, the peripheral edge 223 of the second vibration component 22 is gradually away from the peripheral edge 124 of the first vibration component 12, and the distance between the peripheral edge 223 of the second vibration component 22 and the peripheral edge 124 of the first vibration component 12 gradually increases until the distance between the peripheral edge 223 of the second vibration component 22 and the peripheral edge 124 of the first vibration component 12 reaches a preset maximum value (for ease of description, the maximum value is represented by d2 below).

For example, a surface that is of the first vibration component 12 and that faces the second vibration component 22 is a first surface 125. A surface that is of the second vibration component 22 and that faces the first vibration component 12 is a second surface 221. The distance between the peripheral edge 223 of the second vibration component 22 and the peripheral edge 124 of the first vibration component 12 may be a distance from a periphery 2211 of the second surface 221 to the first surface 125 in the first direction. It should be noted that, in a process in which the peripheral edge 223 of the second vibration component 22 undergoes the reciprocating motion, an included angle may exist between a plane on which the periphery 2211 of the second surface 221 is located and the first surface 125, and distances from different positions on the periphery 2211 to the first surface 125 may be different. In this case, the distance from the periphery 2211 of the second surface 221 to the first surface 125 may be an average value of distances from each position on the periphery 2211 to the first surface 125.

In a process in which the peripheral edge 223 of the second vibration component 22 undergoes the reciprocating motion, a real-time distance from the periphery 2211 of the second surface 221 to the first surface 125 in the first direction is dt, where d1≤dt≤d2. That the acoustic channel 102 opens and closes at the second frequency may be understood as that a main change frequency of dt is the second frequency.

In some embodiments, d1 may be 0 mm. It should be noted that, due to a process limitation, in a manufacturing and assembling process of the sound generation apparatus 100, d1 may be a value that is infinitely close to 0, for example, d1≤0.06 mm. In this case, the vibration space 101 does not communicate with the external space. The acoustic channel 102 blocks 100% of the first acoustic wave, and the first acoustic wave cannot be transmitted to the external space.

When the sound generation apparatus 100 does not work, an initial position of the second vibration component 22 may be set based on an actual requirement, that is, d1≤d0≤d2. This is not limited in this application. The second vibration component 22 shown in FIG. 6 satisfies the following condition: d1<d0<d2. A value of d2 is not limited in this application, and may be designed based on a requirement.

In FIG. 5, a dashed line is used to show a location S1 at which the distance between the peripheral edge 223 of the second vibration component 22 and the peripheral edge 124 of the first vibration component 12 reaches the preset minimum value (dt=d1), a location S2 at which the distance between the peripheral edge 223 of the second vibration component 22 and the peripheral edge 124 of the first vibration component 12 reaches the preset maximum value (dt=d2), and a location S0 when the second vibration component 22 is stationary (dt=d0).

In some embodiments, when the sound generation apparatus 100 does not work, the first surface 125 may be parallel to the second surface 221. In another embodiment, the first surface 125 may alternatively be set at an angle to the second surface 221.

It may be understood that, that the peripheral edge 223 of the second vibration component 22 undergoes the reciprocating motion, to be close to or away from the peripheral edge 124 of the first vibration component 12 is a relative concept. When the peripheral edge 223 of the second vibration component 22 undergoes the reciprocating motion, the peripheral edge 124 of the first vibration component 12 may either remain stationary or also vibrate.

The first vibration component vibrates at the first frequency f₁ to form the first acoustic wave, the first acoustic wave radiates outward along the acoustic channel 102, and the acoustic channel 102 opens and closes at the second frequency f₂ through cooperation of the second vibration component 22 and the first vibration component 12, so that a radiation status of the first acoustic wave can be changed, thereby modulating the first acoustic wave, and generating the second acoustic wave. A frequency of the second acoustic wave may include ¿f₁+f₂∨¿ and ¿f₁−f₂∨¿.

An acoustic wave of the frequency ¿f₁+f₂∨¿ may be an audible sound, or may be an ultrasonic sound. An acoustic wave of the frequency ¿f₁−f₂∨¿ may be an audible sound, or may be an ultrasonic sound. Values of the first frequency f₁ and the second frequency f₂ are set, so that the frequency of the second acoustic wave is controlled. For example, the first frequency f₁ is set to 21 kHz, and the second frequency f₂ is set to 20.5 kHz. In this way, ¿f₁+f₂∨¿=41.5 kHz, and the acoustic wave is an ultrasonic sound; and ¿f₁−f₂∨¿=500 kHz, and the acoustic wave is an audible sound. The second acoustic wave may include two frequencies: 41.5 kHz and 500 Hz, and the sound generation apparatus 100 may emit an ultrasonic sound and an audible sound. For example, the first frequency f₁ is set to 500 Hz, and the second frequency f₂ is set to 550 Hz. In this way, ¿f₁+f_{2∨¿=1050} Hz, and the acoustic wave is an audible sound; and ¿f₁−f_{2∨¿=50} Hz, and the acoustic wave is an audible sound. The second acoustic wave may include sounds of two frequencies: 550 Hz and 50 Hz, and the sound generation apparatus 100 may emit two audible sounds.

The first frequency f₁ may be a single frequency or a frequency band range. The second frequency f₂ may be a single frequency or a frequency band range. It may be understood that the first frequency f₁ and the second frequency f₂ may be set to be a single frequency or a frequency band range to adjust the two frequency bands ¿f₁+f₂∨¿ and ¿f₁−f₂∨¿ that are included in the second acoustic wave to separately be a single frequency or a frequency band range. For example, the first frequency f₁ is 21 kHz, and the second frequency f₂ is in a range from 21.02 kHz to 22 kHz. In this way, a range of ¿f₁−f₂∨¿ is within a range from 20 Hz to 1000 Hz, and is a frequency band range. A range of ¿f₁−f₂∨¿ is within a range from 42.02 Hz to 43 kHz, and is a frequency band range.

In some embodiments, when ¿f₁−f₂∨¿ is a frequency band range, the range of ¿f₁−f₂∨¿ may partially be an audible sound. For example, the range of ¿f₁−f₂∨¿ may be within a range from 20 Hz to 25 kHz. Alternatively, the range of ¿f₁−f₂∨¿ may entirely be an audible sound. For example, the range of ¿f₁−f₂∨¿ is within a range from 100 Hz to 500 Hz.

In some embodiments, the first frequency f₁ and the second frequency f₂ satisfy the following conditions: 20 Hz≤|f₁−f₂|≤20 kHz, and 20 Hz≤∨¿f₁+f₂∨¿. It may be understood that, values of the first frequency f₁ and the second frequency f₂ are set, so that the second acoustic wave includes sounds of two frequencies, one of the sounds is an audible sound, and the other may fall within a frequency range of an ultrasonic wave. When the sound generation apparatus 100 generates a sound, the frequency that is of the second acoustic wave and that is within the ultrasonic range is not received by a user, and the user hears only one audible sound, so that noise of the sound generation apparatus 100 is low.

In some embodiments, the first frequency f₁ and the second frequency f₂ further satisfy the following conditions: f₁≥20 kHz and f₂≥20 kHz. It may be understood that, both the first frequency f₁ and the second frequency f₂ are set to ultrasonic frequencies, and when the sound generation apparatus 100 generates a sound, the first frequency f₁ and the second frequency f₂ are not heard by the user, so that noise of the sound generation apparatus 100 is low. In addition, both the first frequency f₁ and the second frequency f₂ are set to be ultrasonic, which may further ensure that an acoustic wave of the frequency |f₁+f₂| in the second acoustic wave may fall within the frequency range of the ultrasonic wave, so that the acoustic wave of the frequency |f₁+f₂| in space can be inaudible to a human ear. In addition, both the first frequency f₁ and the second frequency f₂ are set to be ultrasonic, so that the sound generation apparatus 100 can obtain a large sound pressure value under a small vibration displacement. When the frequency ¿f₁−f₂∨¿ is an audible sound, the sound pressure value of the second acoustic wave is large, and low-frequency performance of the sound generation apparatus 100 is good.

With reference to the accompanying drawings, the following describes several embodiments in which the second vibration component 22 encloses the acoustic channel 102 together with the peripheral edge 124 of the first vibration component 12.

As shown in FIG. 6, the second vibration component 22 may be an integrated mechanical part. A middle part 222 of the second vibration component 22 may be disposed opposite to the middle part 123 of the first vibration component 12. The middle part 222 of the second vibration component 22 may be fastened to the second base 21. The peripheral edge 223 of the second vibration component 22 is disposed opposite to the peripheral edge 124 of the first vibration component 12. The peripheral edge 223 of the second vibration component 22 may enclose the acoustic channel 102 together with the peripheral edge 124 of the first vibration component 12. In FIG. 6, the middle part 222 of the second vibration component 22 is located between the peripheral edges 223 on two sides.

In another embodiment, in addition to the peripheral edge 223, the second vibration component 22 may have more parts that enclose the acoustic channel 102 together with the peripheral edge 124 of the first vibration component 12. An embodiment is used for description in the following. Details are not described herein.

The acoustic channel 102 may be annular. The acoustic channel 102 may be disposed around the vibration space 101. It may be understood that, compared with a solution in which the acoustic channel 102 is located on one side of the vibration space 101, this solution in which the acoustic channel 102 is set to be annular and disposed around the vibration space 101 may allow a length of the acoustic channel 102 to be longer. In the process of controlling the acoustic channel 102 to open and close at the second frequency, an adjustable range of the acoustic channel 102 is larger.

In some embodiments, the second vibration component 22 may be a piezoelectric sheet. The sound generation apparatus 100 may further include a second feed circuit (not shown in the figure). The second feed circuit may be electrically connected to the second vibration component 22, and is configured to transmit an electrical signal to the second vibration component 22. The second vibration component 22 implements vibration based on the electrical signal. For example, the second vibration component 22 may include a piezoelectric material layer. For example, the piezoelectric material layer may be made of a piezoelectric material like lead zirconate titanate piezoelectric ceramics (lead zirconate titanate piezoelectric ceramics, PZT). The second vibration component 22 starts to vibrate after being powered on. Because the middle part 222 of the second vibration component 22 is fastened to the second base 21, the middle part 222 of the second vibration component 22 does not move, and the peripheral edge 223 of the second vibration component 22 undergoes reciprocating motion.

It may be understood that, compared with a solution in which a conventional mechanical motion structure is used to implement the reciprocating motion of the peripheral edge 223 of the second vibration component 22, the second vibration component 22 uses a structure of the piezoelectric sheet, and the piezoelectric sheet has a smaller size. This helps reduce the size of the sound generation apparatus 100.

It may be understood that, when the second vibration component 22 may be a piezoelectric sheet, a vibration frequency of the peripheral edge 223 of the second vibration component 22 may be controlled through adjustment of a frequency of the electrical signal transmitted by the second feed circuit, and then an opening-and-closing frequency of the acoustic channel 102, that is, a value of the second frequency, is affected.

In another embodiment, the second vibration component 22 may alternatively be of a sheet structure or a plate structure. The sound generation apparatus 100 may further include a second vibration structure (not shown in the figure). The second vibration structure may be a mechanical motion structure, and is configured to drive the second vibration component 22 to undergo the reciprocating motion, so that the acoustic channel 102 may open and close at the second frequency. For example, the peripheral edge of the second vibration component 22 may be fastened to the second vibration structure. It may be understood that a vibration manner of the second vibration component is not limited in this application.

In some embodiments, the reciprocating motion may be implemented as reciprocating rotation or reciprocating movement. The peripheral edge 223 of the second vibration component 22 shown in FIG. 6 undergoes reciprocating rotation.

In some embodiments, a difference between the second frequency and a resonant frequency of the second vibration component 22 may be less than or equal to a threshold. It should be noted that the difference between the second frequency and the resonant frequency of the second vibration component 22 is an absolute value. The second frequency f₂ and the resonant frequency f₄ of the second vibration component 22 is ∨f₂−f₄∨¿. In other words, the second frequency f₂ may be greater than or equal to the resonant frequency f₄ of the second vibration component 22, or may be less than or equal to the resonant frequency f₄ of the second vibration component 22.

In some embodiments, the threshold may be less than or equal to 500 Hz. For example, the threshold may be 500 Hz, and the second frequency f₂ and the resonant frequency f₄ of the second vibration component 22 satisfy the following condition: ¿f₂−f₄∨¿≤500 Hz. In another embodiment, the threshold may alternatively be 20 Hz, 100 Hz, 200 Hz, or the like. It may be understood that the second frequency is set to be close or equal to the resonant frequency of the second vibration component 22, so that the vibration efficiency of the sound generation apparatus 100 can be improved.

It may be understood that the resonant frequency of the second vibration component 22 can be adjusted through adjustment of a material and a geometric size of the second vibration component 22, so that the resonant frequency falls within an expected frequency range. For example, the resonant frequency of the second vibration component 22 is designed to be 23 kHz, to be applicable to the sound generation apparatus 100 that needs to form an audible sound of a medium-and low-frequency. An example in which the second vibration component 22 is of a circular sheet-shaped structure is used for description. The second vibration component 22 includes a piezoelectric sheet and a metal sheet, and a size of the piezoelectric sheet is the same as that of the metal sheet. The piezoelectric sheet can be laminated onto the metal sheet via an adhesive layer. The second base 21 is cylindrical, and is fastened to a center of the second vibration component 22. The resonant frequency of the second vibration component 22 is approximately 23 kHz. The piezoelectric sheet is made of a PZT 5H material, and has a size of 3.56 mm in radius and 0.2 mm in thickness. The metal sheet is made of a nickel-based alloy material, and has a size of 3.56 mm in radius and 0.2 mm in thickness. A cylinder radius of the second base 21 is 0.5 mm. A person skilled in the art may design the second vibration component 22 by using a simulation tool, to allow the resonant frequency of the second vibration component 22 to conform to a preset value.

In some embodiments, a distance between the first vibration component 12 and the second vibration component 22 in the first direction may be less than 1 mm. The first direction is a direction in which the first vibration component 12 faces the second vibration component 22. It may be understood that the distance between the first vibration component 12 and the second vibration component 22 is small, so that a thickness of the sound generation apparatus 100 in the first direction is small, thereby facilitating miniaturization of the sound generation apparatus 100. In addition, a vibration distance of the first vibration component 12 is small, and a vibration amplitude of the middle part 123 of the first vibration component 12 during vibration is also small. When the sound generation apparatus 100 is mounted in internal space of the electronic device 1, in a sound generation process of the sound generation apparatus 100, a risk that the first vibration component 12 drives a housing and/or a keyboard of the electronic device 1 to vibrate can be reduced, and a problem of airflow noise caused by large-amplitude vibration can be further resolved.

In some embodiments, a thickness of the sound generation apparatus 100 in the first direction is less than 2.0 mm. The thickness of the sound generation apparatus 100 is small, thereby facilitating miniaturization of the sound generation apparatus 100.

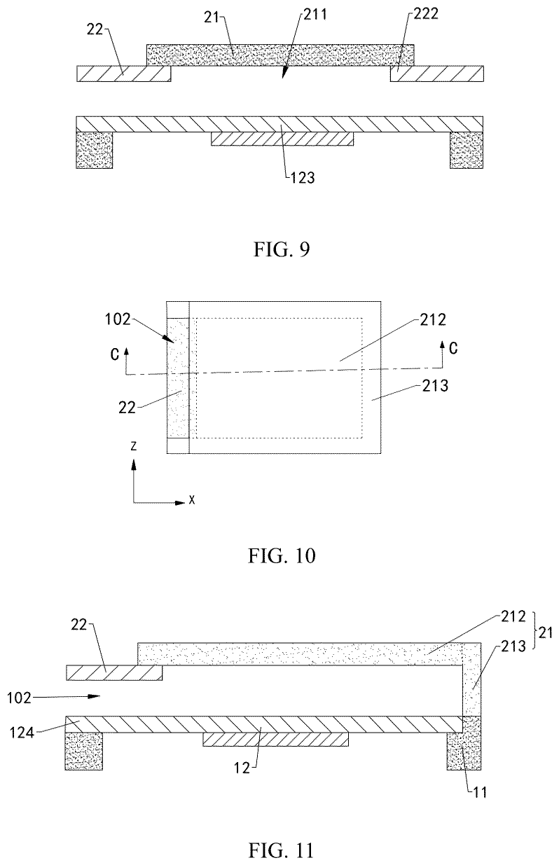

In some embodiments, technical content that is the same as that of the sound generation apparatus 100 in the foregoing embodiments are not described herein again. FIG. 8 is an exploded diagram of another example of the sound generation apparatus 100 shown in FIG. 4. FIG. 9 is a partial sectional view of another example of the sound generation apparatus 100 shown in FIG. 4 along a section line B-B.

As shown in FIG. 8 and FIG. 9, a first through hole 211 may be provided in the middle part 222 of the second vibration component 22. In this case, the overall second vibration component 22 may be in an annular shape (as shown in FIG. 8). The middle part 222 of the second vibration component 22 is fastened to the second base 21. The middle part 123 of the first vibration component 12 may be disposed opposite to the second base 21. The second vibration component 22 may enclose the acoustic channel 102 together with the peripheral edge 124 of the first vibration component 12. The acoustic channel 102 may be annular.

In some embodiments, the middle part 123 of the first vibration component 12 may enclose the vibration space 101 together with the second vibration component 22 and the second base 21. In some embodiments, the middle part 123 of the first vibration component 12 may enclose the vibration space 101 together with the second base 21.

In some embodiments, the second base 21 is fastened to a surface of the second vibration component 22 on a side away from the first vibration component 12. In another embodiment, the second base 21 may alternatively be fastened to an inner wall surface of the first through hole 211.

It may be understood that the first through hole 211 is provided in the middle part 222 of the second vibration component 22, so that a height of the vibration space 101 may be increased without increasing a height of the sound generation apparatus 100 in the first direction, thereby reducing a risk of interference between the middle part 123 of the first vibration component 12 and the second vibration component 22 or the second base 21 during vibration, and reducing a risk of failure of the sound generation apparatus 100. In addition, a size of the second vibration component 22 can be reduced, thereby saving a material, and reducing costs of the sound generation apparatus 100.

It may be understood that a contour of an outer side surface of the second vibration component 22 may be in a circular shape shown in FIG. 8, or may be in a rectangular shape, a triangular shape, or another irregular shape. The first through hole 211 may be in a circular shape shown in FIG. 8, or may be in a rectangular shape, a triangular shape, or another irregular shape. This is not limited in this application.

In some embodiments, technical content that is the same as that of the sound generation apparatus 100 in the foregoing embodiments is not described herein again. FIG. 10 is a diagram of a structure of another example of the sound generation apparatus 100 according to an embodiment of this application from another angle. FIG. 11 is a partial sectional view of an example of the sound generation apparatus 100 shown in FIG. 10 along a section line C-C.

As shown in FIG. 10 and FIG. 11, the first base 11 may be fastened to one side of the second base 21, and the second vibration component 22 may be fastened to one side of the second base 21 and is spaced apart from the first base 11. The second vibration component 22 encloses the acoustic channel 102 together with a part of the peripheral edge 124 of the first vibration component 12. The middle part 123 of the first vibration component 12 may be disposed opposite to the second base 21, to enclose the vibration space 101. In this case, the acoustic channel 102 may be located on one side of the vibration space 101.

It may be understood that, when the acoustic channel 102 may be located on one side of the vibration space 101, the second acoustic wave may be transmitted from the side on which the acoustic channel 102 is located to the external space. A sound emission direction of the sound generation apparatus 100 may be controlled. For example, when the sound generation apparatus 100 is mounted inside the electronic device 1, the second vibration component 22 may be fastened to a side that is of the second base 21 and that is close to the sound outlet 201. A reduced acoustic loss inside the electronic device 1, compared with that in a design using an annular acoustic channel 102, allow a sound emitted by the sound generation apparatus 100 to pass through the sound outlet 201 to the outside of the electronic device 1 as much as possible, resulting in good sound generation effect of the electronic device 1.

In addition, when the sound generation apparatus 100 is fastened to the electronic device 1, either the first base 11 or the second base 21 may be fastened to the electronic device 1, to fasten the sound generation apparatus 100. This configuration, compared with a solution in which the first base 11 and the second base 21 are separately mounted on the electronic device 1, can reduce a risk of misalignment between the first vibration component 12 and the second vibration component 22. This results in high component precision of the sound generation apparatus 100 and low mounting difficulty of the sound generation apparatus 100.

In some embodiments, the first base 11 is fastened to the second base 21, the first base 11 and the second base 21 may form the casing of the sound generation apparatus 100, and the first base 11 and the second base 21 may protect the first vibration component 12 and the second vibration component 22. In this case, the sound generation apparatus 100 is an integral part, and the sound generation apparatus 100 may be used and sold as an independent product.

For example, the second base 21 may include a first part 212 and a second part 213 (the first part 212 and the second part 213 are schematically distinguished by using dashed lines in FIG. 10 and FIG. 11). The first part 212 may be disposed opposite to the first vibration component 12. The second vibration component 22 may be fastened to one side of the second base 21. The second part 213 is connected to one side of the first part 212, and is spaced apart from the second vibration component 22. For example, the second base 21 may be fastened to the first base 11 in an adhesive manner.

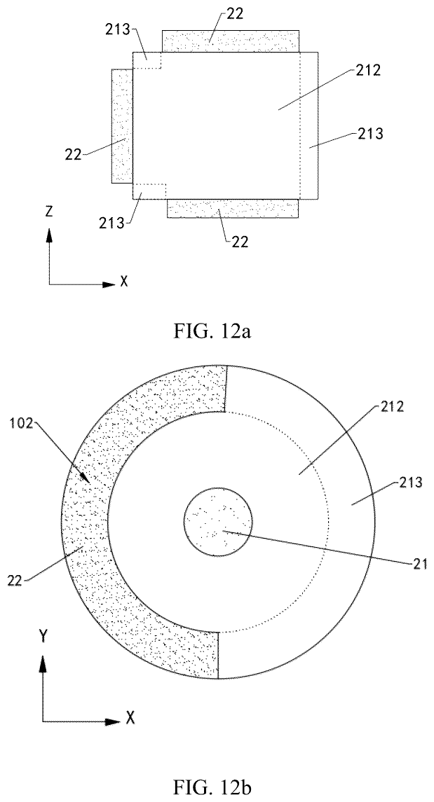

FIG. 12a is a diagram of a structure of still another example of a sound generation apparatus according to an embodiment of this application from another angle.

There may be one or more second vibration components 22. As shown in FIG. 10, there may be one second vibration component 22, and the second vibration component 22 is fastened to one side of the second base 21. As shown in FIG. 12a, there may be a plurality of second vibration components 22, and the plurality of second vibration components 22 are spaced apart from each other. It may be understood that a sound emission orientation of the sound generation apparatus 100 may be adjusted through adjustment of a position of the second vibration component 22.

In some embodiments, when there are a plurality of second vibration components 22, the plurality of second vibration components 22 may enclose a plurality of acoustic channels 102 together with the peripheral edge 124 of the first vibration component 12, and the plurality of acoustic channels 102 may be spaced apart from each other (as shown in FIG. 12a, the acoustic channels 102 are schematically shown by using a filling pattern in FIG. 12a).

FIG. 12b is a diagram of a structure of still another example of a sound generation apparatus according to an embodiment of this application from another angle.

In some embodiments, the first vibration component 12 may be in a rectangular shape, a circular shape, or another polygonal shape. The second vibration component 22 may be in a rectangular shape (as shown in FIG. 10 and FIG. 12a), an arc shape (as shown in FIG. 12b), or another irregular shape. There may be a plurality of choices for a shape of the second vibration component. This is not limited in this application.

A shape of the acoustic channel 102 may be adjusted through adjustment of the shape of the second vibration component 22. In some embodiments, the acoustic channel 102 may be linear or arc-shaped. For example, the acoustic channel 102 shown in FIG. 10 and FIG. 12a is linear (the acoustic channel 102 is schematically shown by a filling pattern in FIG. 10 and FIG. 12a). The acoustic channel 102 shown in FIG. 12b is arc-shaped (the acoustic channel 102 is schematically shown by a filling pattern in FIG. 12b). It may be understood that, when the acoustic channel 102 may be located on one side of the vibration space 101, the acoustic channel 102 may have a plurality of shapes, so that a direction in which a sound is emitted by the sound generation apparatus may be adjusted. For example, when the acoustic channel 102 is arc-shaped, a central angle corresponding to the arc may be adjusted, so that coverage of a sound emitted by the sound generation apparatus 100 may be changed.

The shape of the acoustic channel 102 may be adjusted based on shapes of the first vibration component 12 and the second vibration component 22. This is not limited in this application.

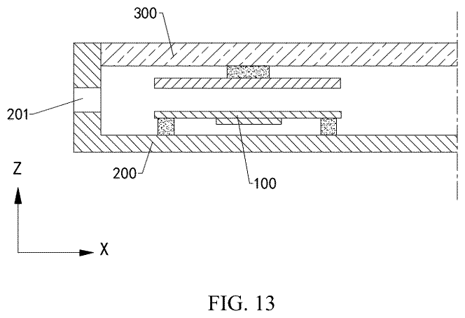

In some embodiments, technical content that is the same as that of the sound generation apparatus 100 in the foregoing embodiments is not described herein again. FIG. 13 is a partial sectional view of another example of the electronic device 1 shown in FIG. 1 along a section line A-A.

As shown in FIG. 13, the electronic device 1 includes a sound generation apparatus 100, a housing 200, and a screen 300. The housing 200 is an integrated mechanical part. The screen 300 is mounted on the housing 200. The screen 300 may enclose an internal cavity of the electronic device 1 together with the housing 200. The sound generation apparatus 100 may be mounted in the internal cavity of the electronic device 1. The screen 300 and the housing 200 form a casing of the electronic device 1.

For example, the sound generation apparatus 100 may include a first transducer 10 and a second transducer 20. The first transducer 10 includes a first base 11 and a first vibration component 12. A peripheral edge of the first vibration component 12 is fastened to the first base 11. The second transducer 20 includes a second base 21 and a second vibration component 22. The second vibration component 22 is fastened to the second base 21. The first base 11 may be fastened to the screen 300, and the second base 21 may be fastened to the housing 200.

In another embodiment, the first base 11 may alternatively be fastened to the housing 200, and the second base 21 may alternatively be fastened to the screen 300.

The sound generation apparatus 100 in this application may be configured to form an audible sound of a medium-and low-frequency (e.g., 20 Hz to 2000 Hz), or may be configured to form an audible sound of a full frequency band (e.g., 20 Hz to 20000 Hz). The sound generation apparatus 100 may be used individually, or a plurality of sound generation apparatuses 100 may be used in combination. Alternatively, the sound generation apparatus 100 may be used in combination with other speakers of a same type or different types such as a piezoelectric speaker and a moving-coil speaker. For example, the sound generation apparatus 100 in this application implements an audible sound of a medium-and low-frequency, and a speaker like a piezoelectric speaker or a moving-coil speaker implements an audible sound of a high frequency.

It may be understood that embodiments of this application and features in embodiments may be combined with each other when there is no conflict, and any combination of features in different embodiments also falls within the protection scope of this application. In other words, the plurality of embodiments described above may be further randomly combined based on an actual requirement.

It may be understood that all the foregoing accompanying drawings are example figures of this application, and do not represent actual sizes of products. In addition, a size proportional relationship between components in the accompanying drawings is not intended to limit an actual product in this application.

The foregoing descriptions are merely embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An electronic device, comprising:
a sound generation apparatus comprising a first transducer and a second transducer, wherein the first transducer comprises a first base and a first vibration component, a peripheral edge of the first vibration component is fastened to the first base, the second transducer comprises a second base and a second vibration component fastened to the second base, and the second vibration component and the first vibration component are disposed opposite to and spaced apart from each other; and
wherein a middle part of the first vibration component and the second transducer enclose a vibration space, the second vibration component and the peripheral edge of the first vibration component enclose an acoustic channel, and the vibration space communicates with an external space through the acoustic channel.

2. The electronic device according to claim 1, wherein a middle part of the second vibration component is disposed opposite to the middle part of the first vibration component and is fastened to the second base, a peripheral edge of the second vibration component is disposed opposite to the peripheral edge of the first vibration component, and the peripheral edge of the second vibration component and the peripheral edge of the first vibration component enclose the acoustic channel.

3. The electronic device according to claim 2, wherein a first through hole is disposed in the middle part of the second vibration component, and the middle part of the first vibration component is disposed opposite to the second base.

4. The electronic device according to claim 2, wherein the acoustic channel is annular.

5. The electronic device according to claim 1, wherein the first base is fastened to the second base, the second vibration component is fastened to one side of the second base and is spaced apart from the first base, the middle part of the first vibration component is disposed opposite to the second base, and the acoustic channel is located on one side of the vibration space.

6. The electronic device according to claim 5, wherein the acoustic channel is linear or arc-shaped.

7. The electronic device according to claim 5, wherein the second transducer further comprises a plurality of second vibration components spaced apart from each other, and the plurality of second vibration components comprise the second vibration component.

8. The electronic device according to claim 1, wherein the second vibration component is circular, annular, rectangular, or arc-shaped.

9. The electronic device according to claim 1, wherein the second vibration component is a piezoelectric sheet, the sound generation apparatus further comprises a second feed circuit electrically connected to the second vibration component and configured to transmit an electrical signal to the second vibration component.

10. The electronic device according to claim 1, wherein a distance between the first vibration component and the second vibration component is less than 1 millimeter (mm) in a first direction, and the first direction is a direction in which the first vibration component faces the second vibration component.

11. The electronic device according to claim 2, wherein
the middle part of the first vibration component vibrates at a first frequency to form a first acoustic wave, the peripheral edge of the second vibration component undergoes a reciprocating motion to allow the acoustic channel to open and close at a second frequency different from the first frequency, and the first acoustic wave is modulated by the acoustic channel to form a second acoustic wave; and
the second acoustic wave comprises an audible sound, and the first frequency is greater than a frequency of the audible sound of the second acoustic wave.

12. The electronic device according to claim 11, wherein the reciprocating motion is a reciprocating rotation or a reciprocating movement.

13. The electronic device according to claim 11, wherein
a difference between the first frequency and a resonant frequency of the first vibration component is less than or equal to a threshold; or
a difference between the second frequency and a resonant frequency of the second vibration component is less than or equal to the threshold;
wherein the threshold is less than or equal to 500 Hz.

14. The electronic device according to claim 11, wherein the first frequency is a single frequency or a frequency band range; and
the second frequency is a single frequency or a frequency band range.

15. The electronic device according to claim 11, wherein a frequency of the second acoustic wave comprises ¿f₁−f₂∨¿ and ¿f₁+f₂∨¿, |f₁−f₂| at least partially falls within a range that is less than or equal to 20 kHz, 20 kHz≤f₁+f₂∨¿, f₁ is the first frequency, and f₂ is the second frequency.

16. The electronic device according to claim 11, wherein f₁≥20 kHz, f₂≥20 kHz, f₁ is the first frequency, and f₂ is the second frequency.

17. The electronic device according to claim 1, further comprising a housing, wherein the sound generation apparatus is mounted on the housing.

18. The electronic device according to claim 6, wherein the second transducer further comprises a plurality of second vibration components spaced apart from each other, and the plurality of second vibration components comprise the second vibration component.

19. The electronic device according to claim 2, wherein the second vibration component is a piezoelectric sheet, and the sound generation apparatus further comprises a second feed circuit electrically connected to the second vibration component and configured to transmit an electrical signal to the second vibration component.

20. The electronic device according to claim 2, wherein a distance between the first vibration component and the second vibration component is less than 1 millimeter (mm) in a first direction, and the first direction is a direction in which the first vibration component faces the second vibration component.
